(19) United States
(12) Patent Application Publication
(10) Pub. No.: US 2005/0211453 A1
(43) Pub. Date: Sep. 29, 2005

(54) Reinforced overhead multipurpose cable for outside telecommunications

(76) Inventors: Fermin Marquez Arzate, Queretaro (MX); Victor Osornio Osornio, Queretaro (MX)

Correspondence Address: Law Office of Carmen Pili Ekstrom, 727 Sunshine Dr., Los Altos, CA, 94024, US

(21) Appl. No.: 10/898,509

(22) Filed: Jul. 22, 2004

(30) Foreign Application Priority Data
Mar. 26, 2004 (MX) PA/A/2004/002843

(51) Int. Cl. H01B 11/02

(52) U.S. Cl. 174/40 R

(57) ABSTRACT

Reinforced overhead multipurpose cable for outside telecommunications of Voice, Video, and Data Distribution (VVDD) type consisting of: a multipair construction core, electromagnetic shielding elements and external protection thermoplastic cover, characterized because it includes one or several externally placed metal or plastic supporting elements for cable self-support; a core integrated by insulated electrical conductors of 2 to 300 twisted pairs, formed with twisting closed lay lengths and reduced in the formation of said component pairs; a plastic tape helicoidally arranged; a tape wrapping the assembled core; said tape being of aluminum for electromagnetic shielding and an external insulating cover both for the core and the reinforcement element and optionally swellable powder not affecting the conductance or capacitance or resistance of the insulation.

### BACKGROUND OF THE INVENTION

1. Field of the Invention

The instant invention relates to the development of an overhead multipurpose cable for outside telecommunications, of Voice, Video, and Data Distribution (V V D D) type, longitudinally and externally reinforced with a support vein, permitting the obtainment of a telephone cable with larger bandwidth levels of operation, and conserving the operation frequencies for voice transmission.

2. Previous Art

The communication cables for interior use based on metal conductors, with polyolefin insulation, formed in pairs and without shielding insulating them against electromagnetic interferences have shown an ever faster development in such a way that today they can be used in frequency ranges of up to 250 MHz, according to US specifications Nema WC 66-99. The field of application of said cables has basically been the local area networks (LAN), houses, apartment buildings or industrial buildings, public buildings, intelligent buildings or schools. The growth of local area networks has caused that the users of digital services such as internet, video on demand, high definition television, teleconferences, voice and fax services, request telephone networks having the adequate flexibility to give said services with high quality and higher transmission speeds that the ones currently available in the outside plant telephone cables which have not evolved much with regard to technical changes. Innovations regarding telecommunication cables are known. For example, U.S. Pat. No. 5,739,473 describes a flame retardant telecommunication cable for use in office buildings; said cable consists of a conductor array insulated in groups of twisted pairs and the insulation used in the core group is different from the insulation used in the surrounding groups, its main characteristic being the arrangement of its structure and the use of a fluorinated copolymer. U.S. Pat. No. 4,319,071 describes a telephone communication cable with a large number of pairs of small conductors, the main characteristic of which is a liquid filling based on waterproof paraffin oils.

The instant invention is an improvement on Mexican patent application PA/a/2000/006808, which relates to a multiple purpose telephone cable with operation levels of larger bandwidth, from 0 to 100 MHz together with the maintenance of operation frequencies for voice transmission.

The voice, video, and data distribution (V V D D) cables show an improvement with regard to the electromagnetic interference levels between adjacent pairs or between the sector or groups constituting the cable and multipair telecommunication cables are obtained with constructions that can include from 2 to 600 pairs.

The geometrical formation of the cables can vary depending on the final installation of said cables. Said installation can be directly underground or in telephone ducts in case of geometrically rounded cables.

The characteristics of the improved cable relate to its use, i.e. the cable is designed for overhead use and thus said cable does not have the filling preventing moisture penetration such as gel materials or can contain swellable powder not affecting the conductance o capacitance or insulation resistance, and also relate to the self supporting capacity of the cable, related with the weight which depends on the number of the twisted pairs included in the cable design which is generally lower compared to the number of pairs for cables for ducts or underground purposes.

### DESCRIPTION OF THE INVENTION

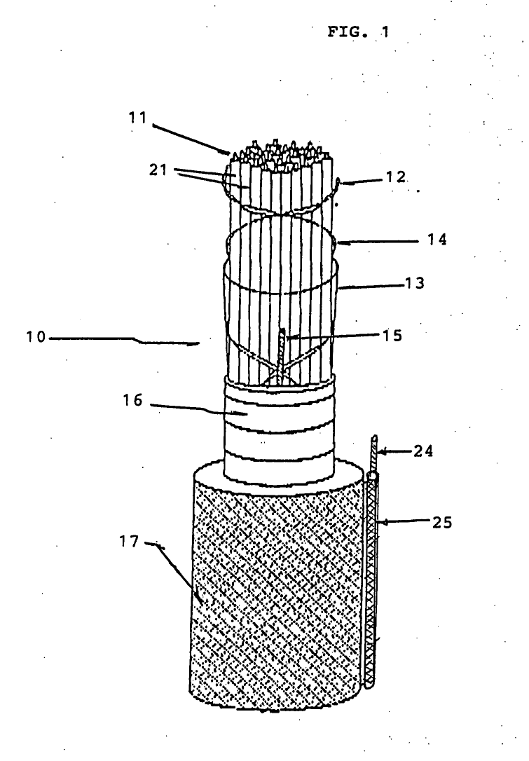

Hereinafter, the invention will be described with reference to the drawing of FIGS. 1 to 4, 5a, b, c and 6, wherein:

FIG. 1 is a cross sectional front view showing the different sections constituting the overhead reinforced multipurpose cable for outside telecommunications.

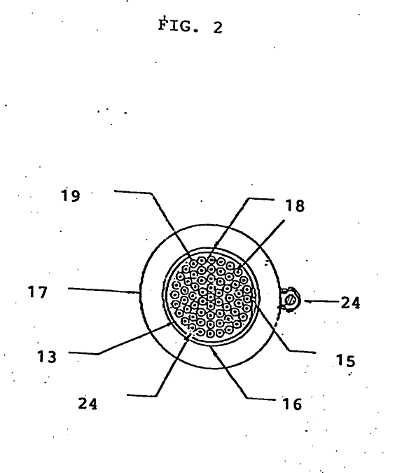

FIG. 2 is a cross sectional view of the cable of FIG. 1.

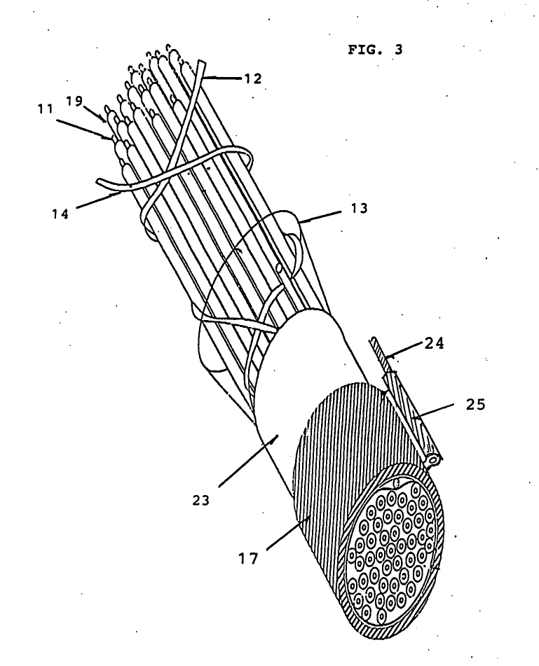

FIG. 3 is an exploded isometric view of FIG. 1 showing the multipair groups in their different arrangements and a self supporting reinforcement element.

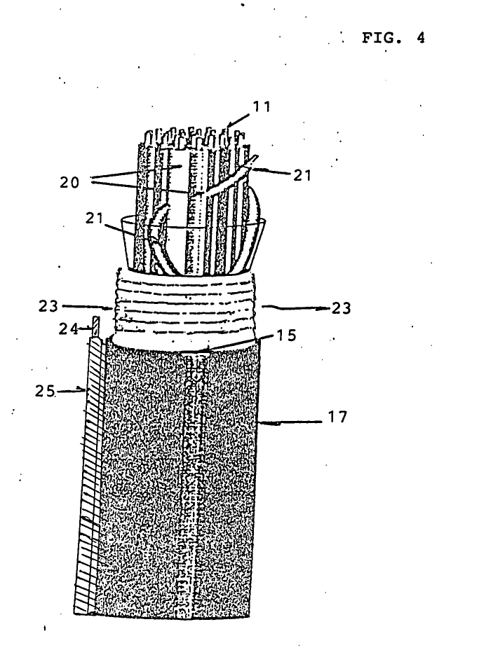

FIG. 4 is a front view of the multipair construction of the reinforced core of FIG. 1.

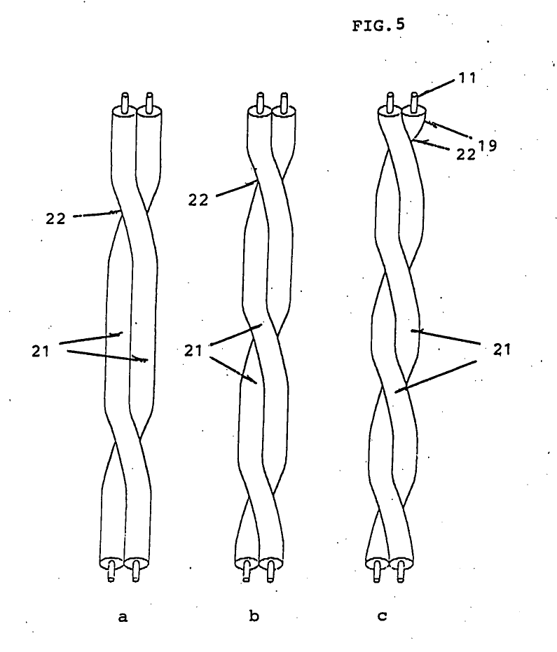

FIGS. 5a, b, c are front views showing the difference regarding the twisting pitches in pairs a, b and c.

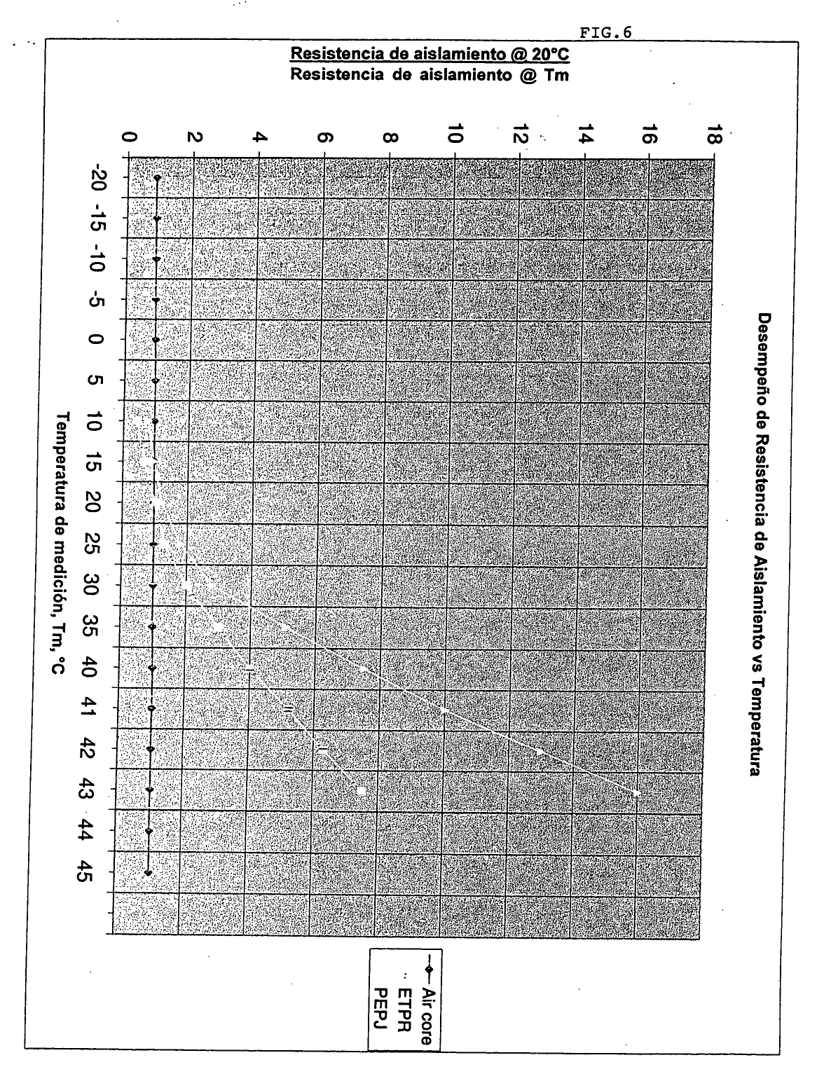

FIG. 6 is a chart showing the performance of insulation versus temperature.

The cables for applications in Voice, Video and Data signals Distribution (VVDD) present the same design and manufacturing technology of varying the twisting lay lengths to lower the diaphony effect when high frequency signals circulates through twisted pairs (up to 100 MHz) as is the case in equivalent cables for duct applications. However, the overhead cables have a lower pair capacity because of the weight factor, i.e. the capacity varies between 2 and 300 pairs and they are not filled with flooding compounds preventing moisture penetration because as they are overhead cables, they are not exposed to flooding phenomena as in the case of underground cables. It has also been shown that the flooding compound would have a negative impact on overhead cables because during hot sunny days, there is a cable temperature increase and this situation increases the temperature of the flooding compound which in turn causes an increase of the compound dielectric constant as well as an increase of the transmission parameters such as attenuation resulting in higher signal losses in the cable and eventually connection failures because of network unbalance, or insulation resistance.

VVDD-type cables of the instant invention are reinforced with a support element which is a carbon steel cable of one or several strands permitting flexibility when the breaking load has to be increased because of the weight of the cable. The weight of the cable depends on the capacity of the cable as well as the gauge of its conductors. The support element of the cable is united to the cable through an integral cover but separated from the core of transmission pairs through a vein or tie.

The cable of the instant invention is also electrically improved, especially with regard to paradiaphony values and electromagnetic interference levels among the groups. The interference level among adjacent sectors or groups in the same cable usually has a minimum value of 9 db (decibels) in order to ensure a better electric performance compared to the electromagnetic interference levels currently known in conventional telephone cables.

To improve the cable electric characteristics, “shorter” (optimized) pairing lay lengths are used, compared to conventional outside plant telephone cables. The length reduction of the pairing lay lengths allows the cable to have the capacity to be used in a larger bandwidth because through the reduction of the pairing lay lengths a cable is obtained having better balanced pairs which minimizes the effect of electromagnetic induction among pairs of the same group and among pairs of different groups (a smaller number of disturbers). For this reason, the cable can be used in transmission systems integrating services where better and larger transmission qualities are requested at higher speeds, as well as pair multiplexion. Examples of services where said cables can be used are: ISDN (Integrated Service Digital Network), ISBDN (Integrated Services Bandwidth Digital Network), xDSL (Digital Subscriber Line), and other services. The design of the cable includes diaphony values in operation frequencies up to 100 MHz.

The increase of the operation bandwidth of the VVDD cables permits to increase the number of signals or transmissions circulating through the twisted pairs constituting the cable. The metal conductor used as core conductor in this type of cables shows a smooth and uniform superficial finishing as well as a constant diameter contributing globally to the fact that the cable can offer better attenuation values and entrance impedance as well as characteristics, which are also important factors in the performance of the electric cable. In the same way, the insulating material extruded on the core conductor shows 10% maximum eccentricities in the total of the insulated conductors, which contributes to generate better mutual capacitance values, having a positive impact on the final results, especially with regard to the electromagnetic interference levels (paradiaphony) among adjacent pairs in the same group or among pairs of different groups or sectors in the finished cable.

The above mentioned improvements together with the optimized pairing lay lengths (with narrow tolerances), and the random assembly of the pairs and the final cabling of the groups or sectors, combine to offer as a result a VVDD telecommunication cable with improved electrical performance and better self supporting capacity.

The above explanation means that the pairs constituting the cable show a better sizing throughout its length and a lower mechanical wear during the manufacturing process, permitting as a global result the lowering of the electromagnetic interference levels (paradiaphony) among pairs, sectors or groups in a given cable, providing as a consequence a cable that can operate within a much wider range of frequencies (0-100 MHz).

The overhead VVDD cable object of the instant invention is a dry core cable, i.e. it does not include hygroscopic filling material among the components or conductors forming the finished cable, or can contain a powder swellable material as remote prevention agent against moisture in the overhead insulation which does not affect the conductance or capacitance or resistance of the insulation, because it is one of the cable electrical parameters that show important changes because of the temperature and the presence of materials preventing moisture penetration such as gels, as can be seen on the diagram of FIG. 6.

The multiple purpose overhead cable for outside telecommunications 10 FIG. 1, object of the instant invention, has a sectioned cylindrical shape with a longitudinal appendix 24 extruded at the sheath 17, and practically without spaces, i.e. without interstices because of the way the pairs of conductors are united, said cable consists of the following parts: several electric conductors 11, made of metal for telecommunications purposes forming the main core of the outside plant cable 10, in 19, 22, 24 and 26 AWG gauges, insulated with a polyolefinic material plastic layer 19, FIG. 2, presenting a minimum conductor eccentricity, being said core characterized by constructions from 2 to 300 twisted pairs 21, FIG. 1, formed with optimized twisting lay lengths different among them, FIGS. 5a, b, c, 22 and components of the groups or sectors of the finished cable, permitting an important reduction of the electromagnetic interference levels (paradiaphony in db). This is obtained through a careful selection of the twisting lay lengths involved and a random assembly of the pairs to finally form the groups or sectors 20, FIG. 4, of the cable components 10, FIG. 1.

An important additional factor to obtain higher electrical results is the fact that the tolerances of the twisting lay lengths in the pairs are kept within a minimum variation range (generally ±1 mm). The object of said minimum variation range is that if during the random assembly, pairs with similar twisting lay lengths are in contact, no phenomenon of transmission area invasion is produced with the corresponding generation of electromagnetic induction; a plastic tape for the union 12 and 14 of the array of pair sectors 21, FIG. 1, a plastic wrapping tape 13, FIG. 3 as fastening element fort the united core; a rupture thread 15, projecting longitudinally along the cable 10, and an aluminum wrapping tape 16, concentrically arranged with regard to the core with corrugated or smooth internal and external walls 23 to inhibit the penetration or exit of electromagnetic radiation, an insulating external cover 17 based on low and medium density polyolefins; a reinforcing element 24 for cable self support 10, said reinforcing element being made of carbon steel formed by filaments of only one gauge or several gauges to form the desired gauge or formed by several high resistance and flexible plastic elements according to the requested cable weight. Said reinforcement and support element is extruded with an integral cover 25 and externally extruded to the cable sheath 17.

Manufacturing Process of the Multipurpose Cable for Outside Telecommunications:

The basic parts constituting the overhead multipurpose cable of the instant invention according to FIGS. 1 to 6 of the drawings are the following ones:
Softly tempered metal conductor 11, FIG. 1, 19, 22, 24, and 26 AWG gauges, with insulation 19 made of solid, or foamed with solid layer protection polyolefin, with adequate thickness to meet the requested electrical parameters;
Assembly elements 12, 14 to fasten and identify the different sectors or groups of twisted pairs constituting the complete cable;
Dry core. The cable does not need non-hygroscopic material filling. This fact diminishes the weight of said cable and compensates partially the weight of the reinforcement element.
Shield 23, according to the case. This component is usually applied as a smooth, FIG. 3, or corrugated, FIG. 4, longitudinal shape. The overhead installation of the cable prevents the corrosion of the metal materials involved.
External cover 17 made of material based on low or medium density polyolefins.
   Manufacturing Process:

The manufacture of the cable is conducted according to the following steps: a) tandem process, i.e. drawing-insulation, in which the copper wire passes through a series of drawing dies where it is submitted to successive transversal area reductions in order to obtain the final diameter of the design (19, 22, 24, 26 AWG); in this same step, the core conductor already at its final size is annealed to change its temper from hard to soft, in this way an at least 15% elongation is obtained; b) after the annealing of the material, it is guided to an extruder in which the wire is forced through an extrusion head in which the guide and the extrusion die are located, which is the part that determines the size of the final diameter of the insulation. Said sizing occurs at the time when the solid or foamed insulation material with a solid protection layer is extruded through the extruder existing in the process line to the extrusion die. It is also in this stage that the eccentricity level between the metal conductor and the insulation applied is checked in such a way that it is 10% maximum.

The step of pairing VVDD cables with fewer than 10 pairs is conducted separately and then the pairs are cabled in order to obtain the final configuration. The pairing and the cabling steps are selected in such a way that the electromagnetic induction (paradiaphony) between pairs of a group or groups or different sectors are minimized, which gives as a result a higher electrical performance, especially with regard to paradiaphony. In the step of pairing-cabling cables with a number of pairs≧10, the insulated conductors are assembled in pairs with optimized pairing lay lengths to ensure a high electrical performance of the cable, especially with regard to the paradiaphony parameter among pairs of the same group or among pairs of different groups or sectors. After forming the pairs, said pairs are grouped in sector of 10 pairs, in the case of cables with up to 100 pairs or in groups (5 sectors of 10 pairs) of 50 pairs in the case of cables with 150 to 300 pairs. The sectors or groups are guided thorough the assembling devices to be cabled and to form the core final assembly. The application of the external cover based on low and medium density polyolefins, is also applied in an extruder, using for this purpose guides and extrusion dies according to the final dimension of the cable. Alternatively, the reinforcing element previously assembled with several wires o plastic fibers is extruded together with the sheath but separately from the cable core. The self supporting elements can be one or several elements depending on the weight of the twisted pairs used.

The above description of the present invention is intended to be illustrative and not to limit the scope of the claims.

1. A reinforced overhead multipurpose cable for outside telecommunications, of voice, video, data and distribution (VVDD) type, comprising:
a multipair construction core;
a plurality of electromagnetic shielding element and external thermoplastic protection cover, comprising a metal or non-metal self-supporting reinforcing element which is united to the cable in the external integrated cover of the cable but separated from the core of transmission pair sections;
a plastic tape helicoidally and longitudinally arranged to unite the individual arrays of pair sectors forming the core;
a plastic wrapping tape covering concentrically said assembled core;
a rupture thread longitudinally projecting along the cable;
and on the outer cover of said cable;
an aluminum wrapping tape tubularly arranged as electromagnetic shielding element;
an outer insulating cover comprising low and medium density polyolefins;
the core being dry and free from fillings, or containing swellable powder placed in the interstices of the core, such that the conductance, capacitance or the resistance of the insulation is not affected.

2. A reinforced overhead multipurpose cable for outside telecommunication according to claim 1 wherein the core is integrated by insulated electrical conductors constructions comprising 2 to 300 twisted pairs, formed with twisting closed lay lengths and reduced in the formation of said component pairs.

3. The reinforced overhead multipurpose cable for telecommunications according to claim 1, wherein the electrical conductors comprises metal conductors made of copper selected from the group consisting of 19, 22, 24, and 26 AWG gauges, said conductor is insulated with a plastic layer comprising polyolefinic material, wherein the metal conductor has a low 10% maximum eccentricity with regard to the size of the final diameter of the insulating layer.

3. The reinforced overhead multipurpose cables for telecommunications according to claim 2, wherein the twisting of the pairs is practically closed between lays, thus presenting a major reduction of the twisting lay lengths, which is obtained through a random assembly of the pairs constituting the groups or sectors forming the multipair cable construction.

4. The reinforced overhead multipurpose cable for telecommunications according to claim 3, wherein the reduction of the twisting lay lengths in the component pairs is about 45% lower than in conventional outside plant telephone cables.

5. The reinforced overhead multipurpose cable for telecommunications according to claim 3, wherein the reduction of the twisting lay lengths offers a closed twisting permitting the decrease of magnetic interference levels.

6. The reinforced overhead multipurpose cable for telecommunications according to claim 3, wherein the twisting pairs are kept within a minimum variation average of about 1 mm, permitting the prevention of possible electromagnetic induction.

7. The reinforced overhead multipurpose cable for telecommunications according to claim 1, wherein the said cable permits to improve the paradiaphony levels in an electromagnetic induction of 9 db and can operate at frequencies within a range of 0-100 MHz of a larger bandwidth.

8. The reinforced overhead multipurpose cable for telecommunications according to claim 1, wherein the self-supporting element comprises carbon steel formed by one or a plurality of twisted metal elements which are united and externally extruded in a sheath comprising polyolefins, alternately united to the main sheath of the cable, the filaments providing flexibility to the cable when it is necessary to increase the breaking load because of the weight of the cable itself.

9. A manufacturing method of the multipurpose cables for outside telecommunications according to claim 1, comprising the following steps:
a) passing the copper wire through a series of drawing dies such that it is submitted to successive transversal area reduction to obtain a sited core;
b) annealing the sized core to change its temper from hard to soft;
c) guiding the annealed material through an extruder in which the wire passes through an extrusion head, in which the guide and the sizing extrusion die are located, in order to determine the final diameter of the insulation;
d) extruding the solid or foamed insulation material with solid protection layer from the extruder existing in the process line up to the extrusion die, such that extrusion occurs with the sizing;
c) rectifying the eccentricity level between the metal conductor and the applied insulation applied.

10. The manufacturing method for multipurpose cable for outside telecommunications according to claim 9 wherein final diameter is selected from the group consisting of 19, 22, 24, 26 AWG gauge.

11. The manufacturing method for multipurpose cable for outside telecommunications according to claim 9 wherein is annealing is conducted at elongations of at least 15%.

12. The manufacturing method for multipurpose cable for outside telecommunications according to claim 9 wherein the eccentricity level is at least 10% maximum.

13. The manufacturing method for multipurpose cable for outside telecommunications according to claim 9, further comprising separately conducting the pairing lays of VVDD cables with fewer than 10 pairs.

14. The manufacturing method for multipurpose cable for outside telecommunications according to claim 13 wherein the pairs are cabled in order to obtain a DINA configuration, the pairing lays are nearly closed, and cabled, selected in such a way that the electromagnetic induction (paradiaphony) is minimized between pairs of a group or between different groups or sectors to produce a higher electrical performance, especially with regard to paradiaphony.

15. The manufacturing method for the multiple purpose cable for outside telecommunications according to claim 14, wherein in the pairing-cabling step of cables with a number of pairs≧10, the insulated conductors are united in pairs with practically closed pairing lays in order to ensure the high electrical performance of the cable.

16. The manufacturing method for the multiple purpose cable for outside telecommunications according to claim 15 wherein the paradiaphony parameter among pairs of one group or among pairs of different groups or sectors, and after the formation of the pairs, said pairs are grouped in sectors of 10 pairs, in the case of cables up to 100 pairs or in groups (sectors of 10 pairs) of 50 pairs in the case of cables comprising 150 to 300 pairs, and then the sectors or groups are guided through assembling devices to be cabled and to form the final core assembly.

17. The manufacturing method of the multipurpose cable for outside telecommunications according to claim 9, wherein a swellable powder is optionally incorporated to the core of the dry cables, the application of the outer cover based on low or medium density polyolefins both to the core of transmission pairs as well as to the element of metal reinforcement separated through a vein, said application being conducted in an extruder through guides and extrusion dies according to the final sizes requested for the cable.

18. The manufacturing method of the multipurpose cable for outside telecommunications according to claim 9 wherein before the operation of the external cover, the shielded core is impregnated with flooding petrolatum to prevent moisture penetration into the cable and to reduce the corrosion of the metal shield.
